(19) United States
(12) Patent Application Publication
(10) Pub. No.: US 2012/0094655 A1
(43) Pub. Date: Apr. 19, 2012

(54) ADAPTIVE CAPACITY AND QUALITY IMPROVEMENTS IN CELLULAR RADIO SERVICES BY THE REMOVAL OF STRONG INTERFERENCE SOURCES

(76) Inventor: Dan Shklarsky, Haifa (IL)

(21) Appl. No.: 09/202,617

(22) PCT Filed: Jun. 10, 1997
(86) PCT No.: PCT/IL97/00188

§ 371 Date: Feb. 14, 2002

(30) Foreign Application Priority Data
Jun. 18, 1996 (IL) 118679

(51) Int. Cl. H04W 24/00

(52) U.S. Cl. 455/423

(57) ABSTRACT

A method for increasing capacity or capacity of a cellular radiotelephone system, in which one cell is a member of more than one reuse group (42, 45). The potential interference risk due to each calling subscriber is assessed (43, 46). The subscriber is assigned to an appropriate reuse group in which he will not be an interferer (44, 47, 48, 49, 50). The method may alternatively be used for the improvement of quality of service (44, 48, 50), i.e., providing reduced probability of interference.

### FIELD AND BACKGROUND OF THE INVENTION

The present invention relates to cellular telephone systems, and, more particularly, to an adaptive method for increasing the conversational traffic-handling capacity of a cellular telephone system.

Cellular telephone systems provide radiotelephone service in a region, say, a city, by dividing the region into cells. In each cell is located a radio transmission/reception tower which communicates with mobile subscriber units in the individual cell. Since the tower in each cell only communicates with subscribers in that individual cell, a radio-frequency communications channel, say, a frequency slot, may be “re-used” in another cell, in a simultaneous conversation/communication in a sufficiently-remote, second cell, so that the simultaneous conversations are non-interfering. The simultaneous conversations in the two cells will be non-interfering if the signal strength of transmissions received in each cell from the other cell is sufficiently low. Both tower transmissions and mobile subscriber transmissions from each cell must be of low amplitude when received at the second cell.

A communications “channel” may be more complicated than a “frequency slot”, for example, a time-division-multiplexed communication on a given frequency may also constitute a “communications channel”. Other modulation-scheme realizations of communications channels are also possible. The present invention is usable will all channel types.

A cellular system includes many cells, which are grouped in repetitive patterns. The grouping into patterns permits benefits in system operation, compared with not using such grouping. For example, without “grouping”, every cell would be potentially subject to interference from strong signals generated in, and emanating from all contiguous, nearest-neighbor cells. By incorporating the cells into groups, the distance between the nearest possible interfering neighbor cell can be increased. Thus, in FIG. 1A, any two cells labelled “A” are separated by the distance of approximately the dimension of the width of two cells, greatly reducing the potential for interference between cells labelled “A”. Similarly, the interference between cells labelled “B”, “C”, etc. is reduced. This will be discussed in more detail below.

“Reuse” is the repetition rate (the number of cells in each “reuse group”) of cells in the communications channel allotments in the cell assignments in a service region. For example, in the cellular regional layout drawing of FIG. 1A, each hexagon is a cell. Each group of seven cells enclosed by a broad outlining is a “reuse group” of cells. The cell in each reuse group with the corresponding letter designation to that in all other reuse groups, is sufficiently distantly physically located from all other cells with that same letter designator, that simultaneous communications in the same communications channel in any two similarly-designated cells will not interfere. This non-interfering situation is primarily a result of signal-strength considerations. Attenuation versus distance of a radio signal is taken to obey an inverse-fourth-power law. Thus, doubling distance from transmitter to receiver results in a decrease of received signal strength by a factor of 2⁴=16. The received signal falls to one-sixteenth of its previous value, for each doubling of distance from transmitter to receiver. On this basis, non-interference between towers, of communications in one communications channel, can be reasonably assured. Also, directional antennas may be used to alter the situation from that implicit in the discussion so far, of omni-directional or “non-directional” antennas at the cell towers.

However, the positions of the mobile subscribers is not subject to control by the telephone service provider, and interfering situations do arise. The interference between subscribers in nearby cells with each other, and with the towers in nearby cells, limits both the capacity of the cellular system, and the quality of the service provided.

Capacity is the number of simultaneous communications conversations the system is capable of handling. Capacity is limited by the need to limit the numbers of simultaneous users of a given communications channel in a given subscriber region. This results in the need for greater number of cells in a reuse group of cells to provide increased distance between similarly-designated cells in FIG. 1A, for example. The greater “reuse” number indicates lower usage of the communications channel resource, i.e., capacity limitation. This is economically disadvantageous, since it implies more towers are needed to maintain a given capacity. Capacity is improved by assigning callers to reuse groups with smaller reuse numbers.

Quality of service in a cellular radiotelephone system is related to reduced probability of interference. Quality of service may be improved by assigning a conversation to a higher reuse number than minimally statistically required. This implies a greater distance between the nearest corresponding cells from which interfering transmissions may originate. Quality is thus improved by assigning callers to reuse groups with greater reuse numbers.

Whether calling subscribers are assigned to reuse groups with greater or smaller reuse numbers is a variable decision which is provided in the present invention, and which may be programmed into the cellular radiotelephone communications system. The decision may be changed with system usage, e.g., as a function of time of day, and day of week or year.

Thus, an important area of research in cellular telephone communications systems is in the area of improvement of cellular communications system communications capacity and quality.

It is a goal of the present invention to provide a cellular telephone communications system with increased capacity or quality.

It is a further goal of the present invention to provide an adaptive method for the provision of increased instantaneous communications capacity or quality.

It is thus a goal of the present invention to provide an adaptive method for maintaining the lowest possible instantaneous reuse of cells, thereby maximizing instantaneous communications capacity; or, alternatively, for providing the option of increasing the reuse of cells to improve the quality of service.

The division of the service area into cells is the core concept in cellular telephony. This division of the service area enables the reuse of spectral resources (which appears as frequency slots or mixed frequency-time slots) in a repetitive way to increase the total amount of radio channels that can be used by the service. This system capacity improvement is very economically desirable, as may well be appreciated, but even more, the frequency spectrum is finite. When the available frequency spectrum is full, then the time-division multiplexing schemes must be considered, at additional hardware expense.

FIG. 1A is an example of a cellular layout with a reuse of seven, in this case the total amount of radio channels is divided into seven subgroups (A to F in the picture) to enable the aerial repetition of seven. Since lower repetition rates, lower reuse numbers, as shown in FIG. 1B, with only three subgroups, result in more available resources, it is the goal of any cellular system to use the lowest possible reuse pattern, i.e., the smallest reuse number. The reduction is limited by the mutual interference which are created between subscribers in adjacent cells while using the same radio resources. This interference is known as Co-Channel Adjacent Cell Interference: CCACI. Since the interference phenomena are stronger when the repetition periods and the distances are shorter the interference limits the minimum possible reuse due to the interference parameters of the radio system.

There are also other types of noise and interference in cellular systems, but in properly designed systems it is the CCACI which poses the major constraint on the system's capacity and quality.

The hexagonal description, which is common in describing cellular structures (as in FIGS. 1A and 1B) dictates six near interferers to and from any cell. Another major property of the hexagonal layout is the partition into the so-called natural “simple” reuse patterns (1, 3, 4, 7, 9, 12, . . . ), in addition to the “non-simple” patterns. The more common simple reuse patterns obey full hexagonal symmetry, in contrast with the non-simple reuse patterns, which in general, do not obey full hexagonal symmetry. The full hexagonal, simple, reuse patterns are easier to implement. The invention here can be implemented in both types of symmetries.

The power of the interference is a very complex random process which is determined by few physical parameters:
1. The position of the subscribers within the cells.
2. The wave propagation properties along the relevant routes (It is strongly related to many aerial properties).
3. The amount of activity at the network.
4. System parameters like: sectorization, power control and voice activity.

Since the actual interference is related to many random physical sources, it is almost impossible to calculate the interference distribution explicitly. Thus, the main way to evaluate the effect of interference is by simulation methods.

The main common assumptions in such simulation evaluations of the interference phenomena in cellular systems are:

Attenuation due to range is commonly described as relative
to the fourth power of the range.
Slow variation wave propagation attenuation effects behaves
according to the random phenomena known as “Shadowing”,
and described by the LogNormal distribution with variance
between six to ten.
In comparative studies, it is common to compare fully loaded
networks.
The amount of voice activity in each channel (up links and
down links) is about 40%.

The above assumptions enable the evaluation and the comparison of various interference situations by using Monte Carlo type approaches to simulate the distribution functions of the interference.

The common approach to evaluate interference effects comparatively is by looking at the point which is determined by the highest decile of the interference distribution. This point is known as the (C/I) 90% point.

Two types of major efforts characterizes the efforts to improve the capacity and the quality of cellular systems:
1. By improving immunity of the radio system to interference.
2. By the reduction of the interference itself.

Important examples of the second approach are sectorization, implementation of accurate power control, and voice activity silencing. Analysis of these methods shows that they are directed to a reduction in the total average power of the interference phenomena, but these methods do not change the nature of the interference distribution functions.

In contrast, the present invention is based on the observation that the interference phenomena in actual cellular systems are dominated by a relatively small group of very strong interferers. Since this is the case, the exclusion from the system of this small group of very strong interferers will reduce the interference picture dramatically. The exclusion of the strong interferers will change the nature of the distribution functions of the interference together with the reduction in the average received power, due to the removal of now-previous strong interferers from the previous distribution functions.

Strong interference is associated with certain subscriber pairs. Each subscriber pair includes an interferer and a victim. The strong interferer subscribers can not be eliminated in prior art cellular communications systems, without the denial of their rights of access to the communications system, which is unacceptable from the service point of view. In order to overcome this constraint, the proposed system will employ two reuse group patterns: (a) short, having a small reuse number (like 3 4 or 7) and (b) longer, having a greater reuse number (like 4 7 9 or 12).

The radio resources will be divided between the two reuse groups according to their interference potential: the small group of strong interferers who generate high interference levels will operate at the longer reuse, while the majority of users, with low potential for interference will be directed to the shorter reuse.

Naturally, the subscribers who are strong interferers at the short reuse, when reassigned to the longer reuse now provide much lower received signal power due to their greater separation distance from cells of the same subgroup (A-F) in FIG. 1A). These previous strong interferers at short reuse are “weakened” by their transfer to the long reuse, and are usually no longer strong interferers at the long reuse.

In addition, the interference's from different cells are partly uncorrelated and the transfer of the strong interferer group to other cells, therefore, creates additional reduction in the interference.

Various attempts have been made to address the problem of strong interferers.

For example, power control, reduction of the tower's and the subscriber's transmitters output power, may be used in both up and down links to reduce the probability of interference in other cells.

Thus, there is thus a widely recognized need for, and it would be highly advantageous to have, a method for reducing interference to signal reception by either the tower or the subscriber in one, first, cell, due to transmissions of either the tower or the subscriber in another, second, cell.

### SUMMARY OF THE INVENTION

According to the present invention there is provided an adaptive method for providing increased capacity or quality in a cellular communications system.

According to further features in preferred embodiments of the invention described below, the adaptive method maintains the lowest instantaneous “reuse”, thereby maximizing communications capacity.

According to still further features in the described preferred embodiments, the adaptive method may be used for the improvement of the quality of service, by reducing the probability of interference to conversations in one cell from simultaneous conversations on the same communications channel in a different cell.

The present invention successfully addresses the shortcomings of the presently known methods of removing strong interferers. The method is relatively inexpensive to implement. The required hardware may be incorporated in existing systems, which employ any type of modulation scheme, and is does not require the subscriber to replace or modify his communications equipment. The hardware and software required by the method identifies probable strong interferers, hence, also identifies probable non-strong interferers. This permits assignment of each conversation in a given cell to the appropriate desired reuse group of those reuse groups available in that cell, to optimize capacity and quality as desired.

The assignment of conversations of low probability of interference, from reuse group of given reuse number, into a reuse group of smaller reuse number provides a method for increasing capacity of the cellular radiotelephone system.

The removal of strong interferers from a reuse group of given reuse number, into a reuse group of greater reuse number provides a method for quality of service improvement. Improved quality of service is understood in this context as the reduced probability of interference from other simultaneous conversations in the cellular radiotelephone system.

The present invention discloses a novel method for removing strong interferers from a cellular radiotelephone communications system reuse group. The method consists of identifying probable strong interferers at a given reuse number and assigning them to reuse groups of higher reuse number, in which they will be probable non-interferers.

More specifically, the method of the present invention, by reassigning probable strong interferes from a reuse group with a smaller reuse number to a reuse group with a greater reuse number changes the statistical probability of the risk of interference in the reuse group with the smaller reuse number, in effect by truncating the tail of the risk-assessment curve which consists of the probable strong interferers. This is illustrated in FIG. 3. The probable strong interferers who were removed from the first reuse group with smaller reuse number, then enter the risk-assessment statistical probability curve of the second reuse group with greater reuse number, but in the body of the statistical risk-assessment distribution, not in the tail, as in the first reuse group. Thus, the strong interferers at the smaller reuse number have been removed from the population, and are no longer probable strong-interferers at the greater reuse number. The method of the present invention, then, consists of the removal of strong interferers.

### BRIEF DESCRIPTION OF THE DRAWINGS

The invention is herein described, by way of example only, with reference to the accompanying drawings, wherein:

FIG. 1A illustrates a cellular reuse of 7;

FIG. 1B illustrates a cellular reuse of 3;

FIG. 2 illustrates mutual interference calculations;

FIG. 3 is an illustration of the risk-assessment map results of identifying probable strong interferers at a given reuse number and removing them to a reuse group of greater reuse number;

FIG. 4 is a flow chart showing assignment of users to reuse groups, depending on probable risk of interference; and,

FIG. 5 illustrates a representative cell communications equipment hardware block diagram.

### DESCRIPTION OF THE PREFERRED EMBODIMENTS

The present invention is of an improved cellular radiotelephone communications system which can be implemented with minimal capital equipment expenditure by the cellular service provider, and with no change in subscriber equipment. Thus, the method of the present invention may be easily retro-fitted into existing cellular systems. Specifically, the present invention can be used to improve capacity of existing cellular systems, and, at times of low system usage, to improve quality of service.

The principles and operation of a cellular radiotelephone communications system according to the present invention may be better understood with reference to the drawings and the accompanying description.

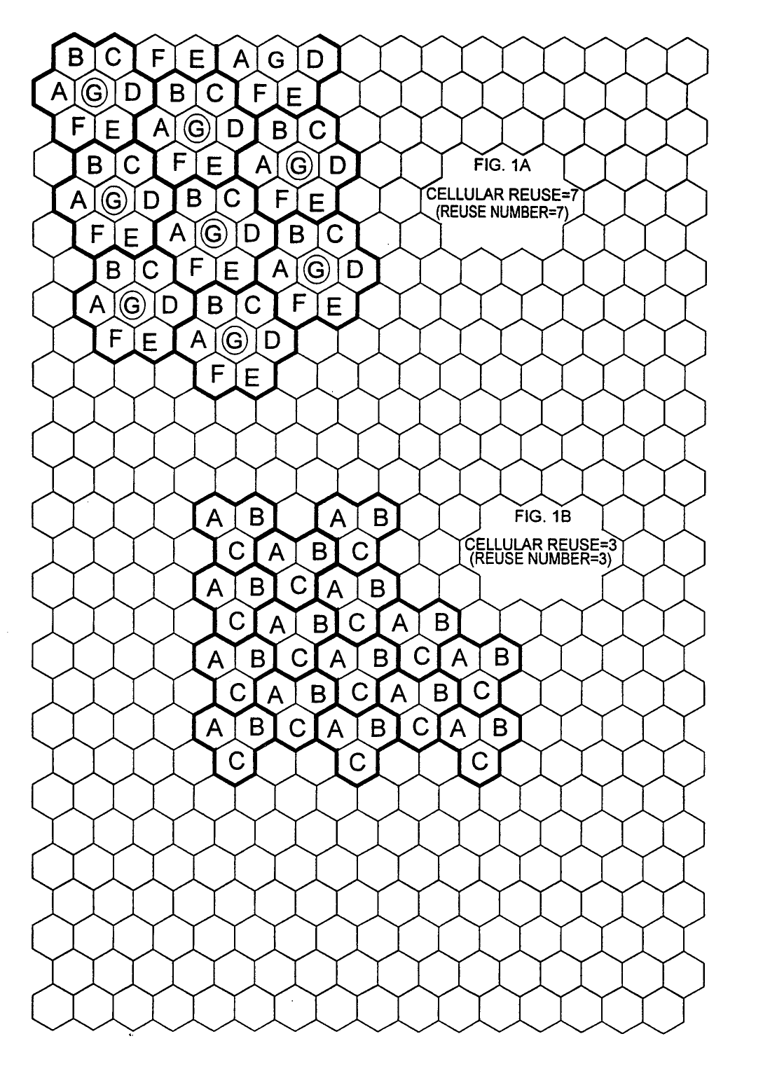

Referring now to the drawings, FIGS. 1A and 1B illustrate two reuse group patterns. Each hexagon represent one cell in the cellular telephone system.

In the prior art, all cells operate with only one reuse number.

FIG. 1A illustrates a cell reuse pattern with reuse number of seven. Each group of seven cells, labelled A through E, is a reuse group. Similarly, FIG. 1B illustrates a cell reuse pattern of three. As can be readily seen, in FIG. 1A, the distance between corresponding cells, cells with a given label, in two adjacent reuse groups, is greater than the distance between corresponding cells in adjacent reuse groups in FIG. 1B. The greater spacial separation results in lower probability of interference, or higher quality of service, with the cellular reuse of seven, than with the cellular reuse of three, assuming a given transmission signal strength. From the other point of view, given a block of 21 adjacent cells, one expects to have three cells of each letter label in FIG. 1A, at a reuse number of seven, while with a reuse number of three, in FIG. 1B, one expects to find seven cells with a given corresponding letter label. This represents increased capacity at a cellular reuse number of three, compared with the capacity at a cellular reuse number of seven.

In method of the present invention, each cell is assigned to multiple reuse groups with different reuse numbers, say, typically two reuse groups. Then if a subscriber conversation is risk-assessed to be a high probability strong interferer at the smaller reuse number, then the conversation is assigned to the reuse group of higher reuse number. This removes the conversation from the population of probable strong interferers at the smaller reuse number, and results in its being a non-probable strong interferer at the greater reuse number.

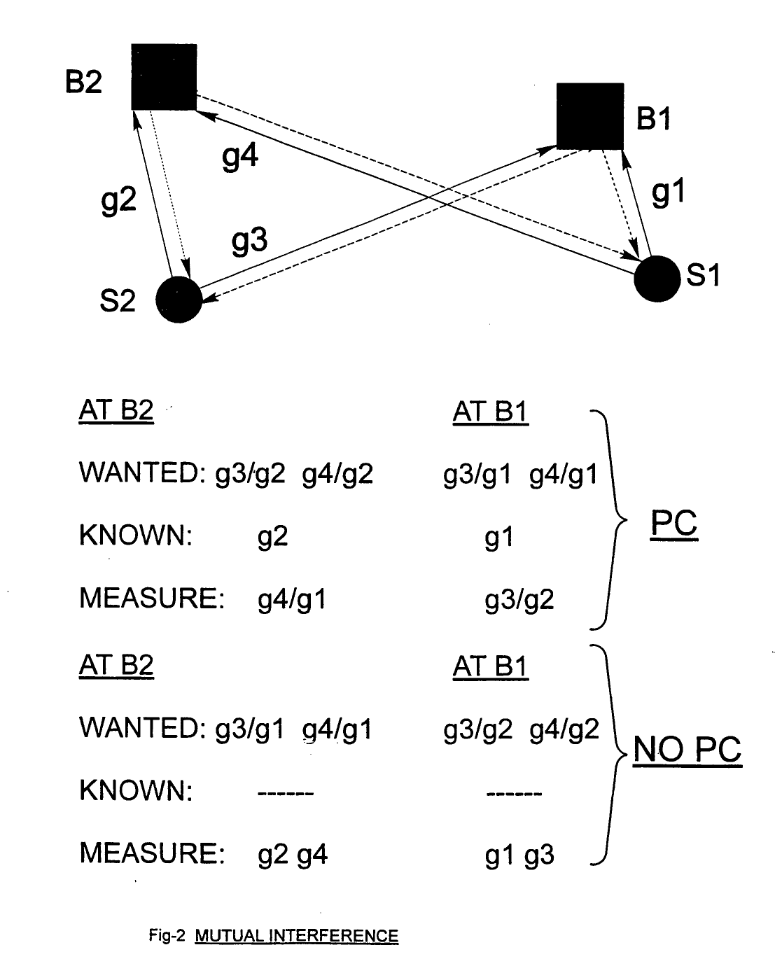

The method of the measurement and the calculation of the mutual interference is illustrated in FIG. 2.

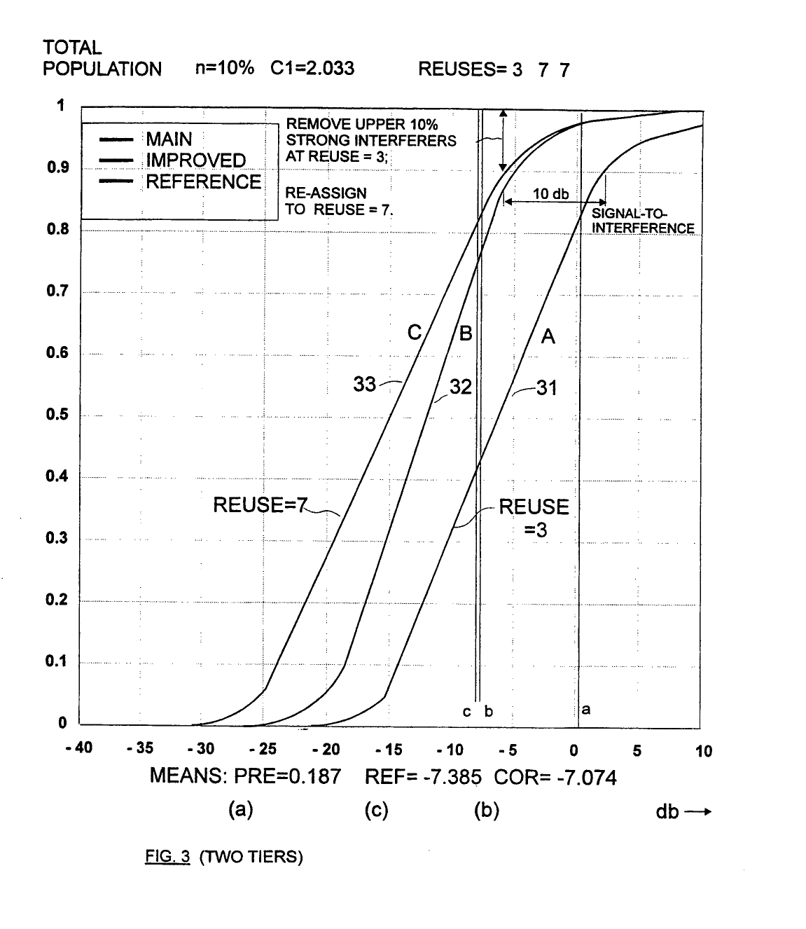

The effect of the removal of the upper ten percent of probable strong interferers at a reuse number of 3, to a reuse number of 7, is shown in the curves of FIG. 3, which will be explained in more detail below.

Each of the curves of FIG. 3 plots the statistical ensemble average of all users of the cellular system for its given case. Each curve is a probability cumulative function (pcf) of the ensemble average of the interference of all users in the cellular system at that instant as seen from a specific cell.

The right-hand curve, 31, corresponds to a reuse number of 3. The left-hand curve, 33, corresponds to a reuse number of 7. The center curve, 32, represents the system performance resulting from the practice of the method of the present invention. The resulting performance is better than the performance at a reuse number of 3, providing performance approximating that of a cellular reuse number of 7, for the top ten percent of strong interferers. In this example illustration, the top ten percent of strong interferers at a reuse number of 3 were removed, and re-assigned to communication “channels” in the cellular system of the present invention, operating at the cellular reuse number of 7. This results in the portion of curve 32 corresponding to the top ten percent of strong interferers in the example system user population to correspond closely to the top ten percent of probable strong interferers at a reuse number of 7. Then, as can be seen from the curves, a 10 dB improvement in signal-to-interference ratio results in the example system, operating according to curve 32.

Alternatively, if the invention were practiced “in reverse”, initially assuming the user population to have been initially at a reuse number of 7, the removal of the upper ten percent of strong interferers to a reuse number of 3, would result in a capacity improvement in the system of a factor of 2.033. Clearly, the invention may be practiced in this “reverse” manner, but only if the signal strength of the upper ten percent of strong interferers at a reuse number of 7 is sufficiently small that this upper ten percent of strong interferers at a reuse number of 7, when “removed” (re-assigned) to a reuse number of 3, really will not cause interference in conversations at a reuse number of 3. This requires that the power level of each of this ten percent of the user conversations at a reuse number of 7 be sufficiently low, that this ten percent of subscribers being removed from the reuse number of seven population will not be actual interferers at a reuse number of 3.

Thus, the present invention may be practiced in either of two “modes”—either in a performance-improvement mode, improving signal-to-noise ratio, in our example, by 10 dB; or in a capacity-improvement mode, in our example approximately doubling capacity, the number of conversations possible in the communications system at a given instant.

The main operations in order to implement the invention are:
Partition of the network into two reuse patterns.
Identification and association of the participants, according to their potential to interfere with their neighbors, in both up links and down links
Transformation of high risk creating participants to the longer reuse.
Maintenance the balance between the two reuse groups according to the systems planning.

The elements which are added to a cellular system in order to execute the above invention accurately are:
1. Measurement and Association Subsystem (MAS).
2. Capacity for sharing of information between adjacent cells.
3. Strong interference identification process.
4. Control process.

A main condition for the implementation of the invention is maintaining an ongoing table (or map) at each base station. This table is used to sort all the existing operations (subscribers) in the cell, at both up and down links, according to the interference threat which they pose to all the conversations in the same and neighboring cells which belong to the reuse group with the smaller reuse number.

Using as an example simple cellular system, as shown in FIGS. 1A and 1B, with “hexagonal” symmetry, and a “long” reuse of seven and a “short” reuse of three, we may discuss an example implementation of the invention:

The first two elements are the tools to supply this table:

1. The measurement and association system (MAS) is basically a multidirectional receiver, based on some kind of a multibeam array antenna receiver. The MAS separates the signals by spatial filtering, before measuring the intensities of the signals. The quality of the separation and the accuracy of the intensity measurements determine the precision of the interference map.

In any cell, with relation to any single resource, the MAS will measure the received average power from all actual users belonging to the reuse group with the smaller reuse number, in all six adjacent cells, and will associate each of these actual possible users belonging to the reuse group with the smaller reuse number, with the cell from which it originates. All the resources that are used by all six nearest neighbors (at the long, e.g., 7, and the short, e.g., 3, reuses) must be included in these measurements. The measurements can be implemented in either of two ways:

Through spatial separation of the signals, followed by frequency separation and measurement of their intensity. In this case, fading effects and voice silencing effects must be neutralized.

Through some temporal separation, followed by frequency separation, done at the appropriate ordinary control channels of the system (for example, whenever a multiplexed time-division protocol exists).

2. An important desired constraint is that all the operations will be executed only by the base stations and not by subscribers. This constraint enables the introduction of the present invention into existing standards and systems, since no additional subscriber equipment is required, but introduces some measurement problems, since only up link interference is measured.

The solution to this measurement limitation problem lies in the capacity for sharing information between adjacent cells. The shared information, together with the measured information at each cell tower (base), results in accurate calculation of the wanted tables at that cell.

3. The base station will evaluate the above table with reference to some predetermined rules (threshold, network load, history, and reuse planning), to grade the potential for interference of each of its operations (present subscriber conversations), in order to make decisions about the appropriate reuse for each conversation. All decisions are executed between the cell base station and that cell base station's own subscribers. 4. Following the decisions, the actual control of the subscribers (i.e., the transfer to the right reuse group) will be implemented through existing control tools of the cellular system.

The system, through its elements, will continue to monitor the interference map and will change the reuse according to the interference situation when needed.

Thus, in order to implement the cellular system as described, it is necessary to add to a prior art system:

(a) a measurement and association subsystem (MAS)

(b) capacity for sharing of information between adjacent cells

(c) strong interference identification process

(d) control process.

The first item includes received power measurement equipment located at each cell tower, under computer control, with programming,

(a) to measure received power for each subscriber conversation in that tower's cell;

(b) to measure received power from all subscriber conversation transmissions at all reuse numbers, in adjacent cells which are in the reuse group having the smaller reuse number, and

(c) to store with the measurements, the information required to identify the source of the measured data (association of the measurement with the subscriber unit and cell the measured data relates to).

The second item, capacity for information sharing, includes providing a communications link between cells in the system, through which the computer at each tower may access the received power measurements data provided in the first item. Since the data is located in a distributed manner, some data in each of the cells in the system, the communications link must include the ability of any given cell to receive from all six adjacent cells in the reuse group of the smaller reuse number all the data (from all the conversations, at all the reuse numbers) relating to the subscribers of the given cell.

The third item, strong interference identification process, includes at each cell, building the instantaneous interference map, including all cell users.

The fourth item, control process, consists of the actual “connection” changes which implement the reassignment decision of the system operation rules (third item) using the results of the measurements (first item) and information sharing (second item).

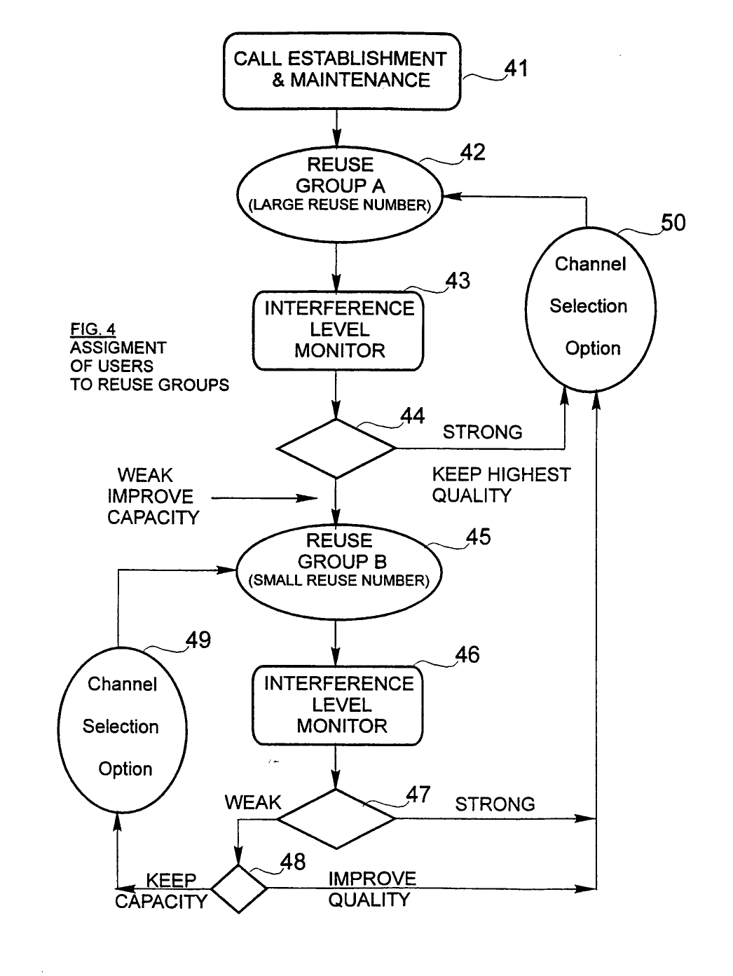

FIG. 4 is a flow chart showing assignment of users to reuse groups, depending on probable risk of interference. Block 41 contains the normal prior art telephone connection technology to establish, maintain, and disconnect telephone conversations. The remainder of the flow chart concerns the assignment of users to reuse groups according to the present invention. In block 42, each newly connected user is initially assigned to the higher reuse number in the system, due to the lower susceptibility to interference for conversations taking place in the reuse group with the larger reuse number. In block 43, the probable risk of interference is continuously evaluated by measurements and calculations, to be described in greater detail with reference to FIG. 2. Then, in decision block 44, if the signal strength of the individual conversation is “weak”, i.e., this subscriber conversation is not a probable interferer at the lower reuse number, then the subscriber conversation may optionally be reassigned to the lower reuse number, block 45, thereby increasing the instantaneous system subscriber conversation volume capacity. Since the instantaneous user population changes with time, in block 46, the decision is continuously re-made, whether each conversation in the reuse group with smaller reuse number is a high-probability interferer, due to having signal strength in the upper ten percent, say, of subscribers. If a conversation would be a high-probability interfering conversation, then in decision block 47 the conversation would be reassigned to the greater reuse number, reuse group A, block 42. If the conversation were not, in effect, forced to be reassigned to the greater reuse number, then as a “weak” (non-“strong”) signal-level conversation, the decision may be made in block 48 to improve conversation quality by the optional reassignment of the conversation to the greater reuse number, thereby reducing interference potential from this conversation to other conversations. Blocks 49 and 50 provide the option of selecting to which of the communications channels (e.g., frequencies) in those assigned to the given reuse group in the given cell the conversation to be assigned will be assigned. The choice of communications channel may be made using the interference map in order to create minimal damage, i.e., to minimize risk of interference between subscribers in the given reuse group. The difference between the two implementation options described above is in decision blocks 44 and 48. The decisions made in blocks 44 and 48 determine whether capacity or quality is to be emphasized. The decisions may be changed, for example, as a function of the time of day and day of the month, or as a function of the percentage of the available communications channels in use. If the decisions are changed, the decisions must be changed simultaneously in all cells in the system. Thus, every cell in FIGS. 1A and 1B will be simultaneously commanded by communication over a supervisory communications channel to reconfigure the decision software. Also, the number of total communications channels in each cell assigned to the smaller and greater reuse numbers may be changed. These changes may be made according to anticipated system usage, or according to actual usage or usage trends.

In conclusion, software decision rules may be changed, but if rules are changed, any rule changes must be made simultaneously for all cells in the whole network.

FIG. 2 illustrates two cases of the FIG. 4, blocks 43 and 46 interference level monitor calculations. The two cases are (a) with power control (PC), and (b) without power control, (NO PC). Power control is a feature of the transmission equipment at each tower. For each conversation, the transmitter power may be either fixed—no power control—or may be reduced to an acceptable level for each conversation—power control—in order to minimize interference. Power control is a prior art option in cellular telephone systems. The importance here is that the present invention can be applied either with or without power control. The system of the present invention may also be applied in cases of virtually all other prior art cellular system options. For example, the present invention may be implemented for any type of modulation system.

In FIG. 2, the squares represent the towers or bases, B1 and B2, in two cells. The circles represent corresponding subscribers, S1 and S2.

### Description of the Measurements and the Information Sharing:

According to the concept of the innovation of the present invention, each cell's tower, base station, is responsible for all the high level interference's which are originated by that cell's base station and by that cell's subscribers. This “responsibility” is realized in that the base station is obliged, by the systems rules, to be aware of the “strong” subscribers and to remove the strong subscribers, according to the method of the present invention, when necessary. Again, “strong” subscribers are the subscribers communicating with large signal levels, such that the probability of interference from these “strong” subscribers is high.

The probability of interference which must be evaluated includes both the probability of interference in uplink (UL) and downlink (DL) transmissions. Uplink refers to transmissions from the subscriber “up” to the tower, while downlink refers to transmissions from the tower “down” to the subscriber.

A possible way, by which a typical base station collects the decision related information is as follows:

The picture of the mutual interference between any pair of base stations and their subscribers is illustrated in FIG. 2, wherein:

g1 is the gain of the channel between B1 to S1.

g2 is the gain of the channel between B2 to S2.

g3 is the gain of the channel between B1 to S2.

g4 is the gain of the channel between B2 to S1.

Each gain is assumed to be bilateral, i.e., the gain from B1 to S1 equals the gain from S1 to B1. Thus g1 is the gain between B1 and S1, as stated above.

Each gains results from the random distance and from a shadowing (LogNormal) propagation random function.

The situation differs slightly between systems with and without power control:

I. Systems With Power Control:

The interference potential created at B1 is determined by g3/g1 (DL) and g4/g1 (UL).

The interference potential created at B2 is determined by g4/g2 (DL) and g3/g2 (UL).

B1 knows g1 and can measure g3/g2.

B2 knows g2 and can measure g4/g1.

So, each of B1 and B2 can calculate its own interference potential through the mutual exchange of gain and gain ratio information between B1 and B2. In this way, both B1 and B2 can create the interference map which is necessary for the removal the strong interference sources through the reuse group reassignment method of the present invention.

II. Systems Without Power Control:

The interference potential created at B1 is determined by g3/g2 and g4/g2.

The interference potential created at B2 is determined by g3/g1 and g4/g1.

B1 can measure g1 and g3.

B2 can measure g2 and g4.

And again, B1 and B2 have together the information which is needed for interference map creation, to permit the removal of strong interferers.

The calculations illustrated above are made between all adjacent cell pairs, in the simplest implementation. Thus the curves of FIG. 3 include a larger population of users than those of their own cell, and in this manner, further assure the prevention of interference between conversations, by the removal of high probability strong interferers to the greater reuse number reuse group.

It will be appreciated that each cell contains some number of communications channels, which may be apportioned as part of the system operating rules between each of the reuse groups in the system at a given time.

Following the calculations in each base station independently, the operations are classified according to their interference potential, and the results are also compared to a preset threshold to determines the absolute risk level. Knowledge of this risk level from blocks 43 and 46 enables the appropriate decisions to be made in blocks 44, 47, and 48, of FIG. 4. The precise nature of this decision will be adaptive and will include various system parameters like network load and subscriber's history.

Thus, the present invention provides for the identification of probable strong interferers by the measurement of signal strengths and ratios of powers between towers and subscribers in cells in the system, and building of interference maps. The interference maps are just the resulting data concerning the signal strengths between the towers and subscribers in the system. This data then fills up the probability curve data population of the curves 31 and 33 in FIG. 3. From this “interference map” data, the upper n %, of strong interferers at a low reuse number may be “removed” by reassignment to a greater reuse number, per the present set of system rules for the decisions of FIG. 4. And the description of the system operation is complete.

As mentioned above, the method of the present invention may be applied to cellular communications systems using any type of modulation control; and may be applied to systems employing, simultaneously, other methods of system capacity improvement, or conversation quality improvement, or interference reduction method, such as power control.

Monte Carlo type simulations of the invention demonstrated substantial reduction at the level of interference compared to existing cellular systems, this advantage will be used as a capacity creation tool, by maintaining lower average reuse, or as higher quality tool at regular average reuse.

Since the concept of reuse is common to all the types of cellular radio system the invention can be implemented in any known system: FDMA, TDMA, DS-CDMA, FH-CDMA etc.

The above improvements were found to be relevant many types of system realizations: with or without power control, with or without sectorization, with or without voice activity, with or without diversity or equalization etc.

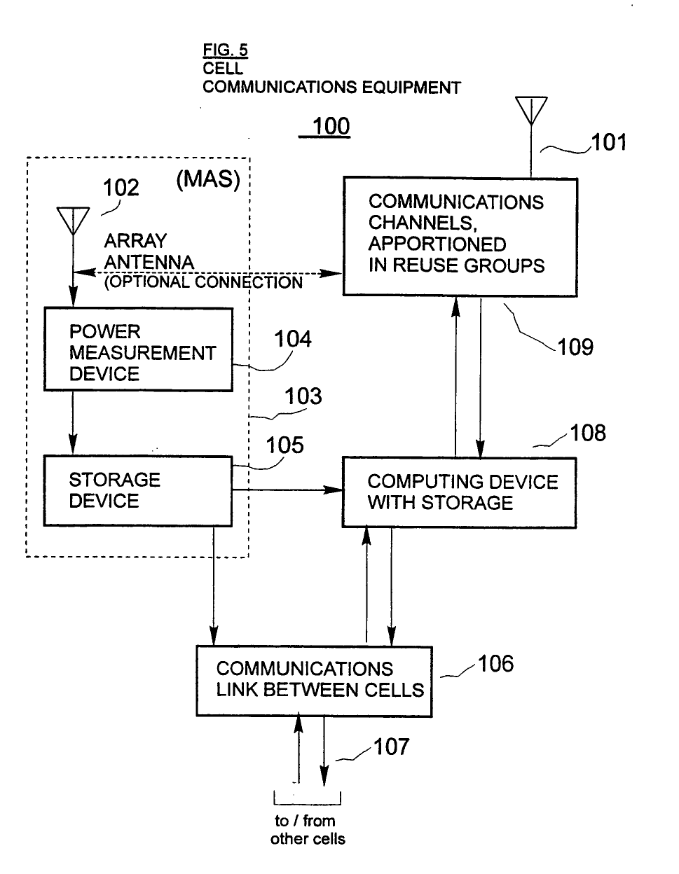

FIG. 5 illustrates a non-limiting representative cell communications equipment hardware block diagram for the practice of the present invention. Antenna, 101, is used for subscriber conversations reception and transmission, and may be used as well for the power measurements of the present invention. Normally, however, array antenna 102 is used for power measurement, only, with conversations carried on via antenna 101. Antenna 102 provides input to power measurement device, 104, which provides measurement and association information to storage device, 105. The association information minimally associates each received power measurement with its subscriber and the cell in which the subscriber is located. Measurement and association system (MAS), 103, consists of blocks 104 and 105 and array antenna 102. Storage device, 105, communicates with communications link, 106, for sharing information between cells via bilateral communications channel represented by lines 107. Communications link, 106, receives data and system rules for storage in 108, a computing device with storage. In conjunction with measurement and association data from MAS, 103, computing device 108 builds interference maps and communicates with block 109, the actual cell communications channels hardware, which is apportioned in reuse groups according to the present invention, to assign subscriber conversations to the appropriate reuse groups. Antenna 101 and block 109 are the existing prior art cellular system hardware. In the prior art, however, all the communications channels in block 109 are totally at the one reuse number of the whole prior art cellular system. Further, the assignment of conversations to the communications channels may be done in such a manner as to further minimize the interference potential between conversations internal to each reuse group, as in blocks 49 and 50 of FIG. 4.

The minimum requirement for antenna 102 is a multibeam antenna.

The preferred antenna 102 is an adaptive multibeam array antenna, which inherently provides spatial filtering.

While the invention has been described with respect to a limited number of embodiments, it will be appreciated that many variations, modifications and other applications of the invention may be made.

What is claimed is:

1. A method for identifying probable strong-interferers in a cellular radiotelephone communications system, comprising the steps of
(a) providing a measurement and association subsystem,
(1) for spatial filtering of all received signals,
(2) for measuring received power at each cell tower, from all possible users in each said cell and first adjacent cell tier which will be included in the interference map for each said cell, and
(3) for storing said measured data with identification association information;
(b) at each cell tower, measuring received power from each subscriber to be included in its interference map;
(c) storing said measured data and association information;
(d) providing a communications link for sharing said measured data and association information between cells;
(e) sharing said measured data and association information between neighbor cells;
(f) calculating an interference table map;
(g) providing system operating rules to all cells in the system, said rules including decision rules defining strong interferer power levels;
(h) identifying the strong interferers by application of said decision rules to said interference table map.

2. A method as in claim 1, further comprising
(f1) providing as part of said system operating rules, rules for partitioning the available communications channels at each cell between all the reuse groups of which each cell is a member; and,
(f2) apportioning the available communications channels in each cell to said reuse groups according to said rules for partitioning said available communications channels.

3. A method for removing probable strong-interferers in a cellular radiotelephone communications system, comprising the steps of
(a) providing at least two reuse groups of different reuse numbers;
(b) identifying the probable strong interferers at each cell;
(c) providing decision conditions for the reassignment of the probable strong interferers in reuse groups of smaller reuse number to reuse groups of greater reuse numbers; and,
(d) reassigning each said probable strong interferer in a reuse group of a small reuse number to a reuse group of a greater reuse number, according to said decision conditions.

4. A method for increasing the capacity of a cellular radio-telephone communications system network, comprising the steps of
(a) partitioning the network into multiple reuse patterns;
(b) identifying and associating the conversations, according to said conversations' potential interference with said conversations' neighboring cells, in both up links and down links;
(c) transforming conversations of high risk of creating interference in a reuse group of a given reuse number to a reuse group of greater reuse number;
(d) maintaining the balance of usage of said multiple reuse groups by said partitioning according to the systems planning; and,
(e) maximizing the number of communications channels at a small reuse number, thereby maximizing system capacity.

5. A method for increasing the quality of a cellular radio-telephone communications system, comprising the steps of
(a) partitioning the network into multiple reuse patterns;
(b) identifying and associating the conversations, according to said conversations' potential interference with said conversations' neighboring cells, in both up links and down links;
(c) transforming conversations of high risk of creating interference in a reuse group of a given reuse number to a reuse group of greater reuse number;
(d) maintaining the balance of usage of said multiple reuse groups by said partitioning according to the systems planning; and
(e) maximizing the number of communications channels at a long reuse number, by assigning not only strong interferers, but as many conversations as possible to a reuse group with large reuse number, thereby minimizing potential of interference in the system.

6. The method of claim 3, further comprising selecting to which communications channel in said reuse group of greater reuse number said probable strong interferer is reassigned in order to minimize risk of interference between subscribers in said reuse group of greater reuse number.

7. The method of claim 4, further comprising selecting to which communications channel in said reuse group of greater reuse number said conversation of high risk of creating interference in a reuse group of a given reuse number is assigned in order to minimize risk of interference between subscribers in said reuse group of greater reuse number.

8. The method of claim 5, further comprising selecting to which communications channel in said reuse group of greater reuse number said conversation of high risk of creating interference in a reuse group of a given reuse number is reassigned in order to minimize risk of interference between subscribers in said reuse group of greater reuse number.

9. A method as in claim 3, further comprising selecting to which communications channels of said reuse groups of small reuse number each conversation is assigned in order to minimize risk of interference between subscribers in said reuse group of small reuse number.

10. A method as in claim 4, further comprising selecting to which communications channels of said reuse groups of small reuse number each conversation is assigned in order to minimize risk of interference between subscribers in said reuse group of small reuse number.

11. A method as in claim 5, further comprising selecting to which communications channels of said reuse groups of small reuse number each conversation is assigned in order to minimize risk of interference between subscribers in said reuse group of small reuse number.

12. A cellular radiotelephone communications system, comprising
(a) a plurality of geographical communications region cells, each cell having a plurality of communications channels which may be apportioned between a plurality of reuse groups of different reuse numbers;
(b) in each said cell, a measurement and association subsystem,
(1) for spatial filtering of all received signals
(2) for measuring received power at each cell tower, from all possible users in each said cell and first adjacent cell tier which will be included in the interference map for each said cell, and
(3) for storing said measured data with identification association information;
including,
(1) a multibeam antenna for spatial filtering;
(2) a received power measurement device for measuring received power from each subscriber to be included in its interference map;
(3) a storage device for said measured data and subscriber association information;
(c) in each said cell, a communications link for sharing said measured data and association information between cells;
(d) in each said cell, a computing device
(1) for calculating and storing an interference table map;
(2) for storing system operating rules to all cells in the system, said rules including decision rules defining strong interferer power levels;
(3) for identifying the strong interferers by application of said decision rules to said interference table map.

13. A method as in claim 1, further comprising
(a) continuously measuring received power from said all possible users;
(b) continuously calculating said interference map; and,
(c) continuously identifying the strong interferers.

14. A method as in claim 3, said identifying further comprising
(a) continuously measuring received power from all possible users;
(b) continuously calculating an interference map; and, (c) continuously identifying the probable strong interferers.

15. A method as in claim 4, said identifying and associating further comprising
(a) continuously measuring received power from all possible said conversations;
(b) continuously calculating an interference map; and,
(c) continuously identifying said conversations of high risk of creating interference in a reuse group of a given reuse number.

16. A method as in claim 5, said identifying and associating further comprising
(a) continuously measuring received power from all possible said conversations;
(b) continuously calculating an interference map; and,
(c) continuously identifying said conversations of high risk of creating interference in a reuse group of a given reuse number.
